(19) United States
(12) Patent Application Publication
(10) Pub. No.: US 2006/0259557 A1
(43) Pub. Date: Nov. 16, 2006

(54) METHOD FOR CONTROLLING ELECTRONIC MAIL

(76) Inventors: Chun-De Lin, Taipei City (TW); Yi-Hung Shen, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/161,306

(22) Filed: Jul. 29, 2005

(30) Foreign Application Priority Data
May 12, 2005 (TW) 94115331

(51) Int. Cl. G06F 15/16

(52) U.S. Cl. 709/206

(57) ABSTRACT

A method for controlling outgoing electronic mails is disclosed. The method automatically checks whether the inputted mailing address is one among a list of predetermined mailing addresses obtained by means of providing users with a new field for entering mailing addresses or clicking a predetermined button after entering mailing addresses. This prevents the need to exclude external mailing addresses or to re-enter mailing addresses and the disadvantage of incomplete information security due to deletion mistakes or omission.

### CROSS-REFERENCE TO RELATED APPLICATION

This application claims the priority benefit of Taiwan application serial no. 94115331, filed on May 12, 2005. All disclosure of the Taiwan application is incorporated herein by reference.

### BACKGROUND OF THE INVENTION

1. Field of the Invention

The present invention relates to a method of processing electronic mail. More particularly, the present invention relates to a method of controlling the electronic mail by limiting the mailing address of the electronic mail.

2. Description of the Related Art

In this all-too-familiar networking world, electronic mail has gradually replaced the conventional mailing method. In most company, people use electronic mail to communicate with their clients or between each different department in the company. However, some information security may be occurred, because the personnel carelessly send the electronic mails, which are intended only for company's internal use, to clients or another company.

Furthermore, to reply through the original document, the person receiving of the document can be internal staffs or external customers. If the user needs to reply the document to other staffs within the company, the internal mailing addresses of the company have to be manually checked and selected or have to re-enter the internal mailing addresses of the company again. As a result, precious time is wasted and special attention needed. Moreover, it is possible to make deletion mistakes or omission if one is not careful. Ultimately, this may lead to similar information security problems.

### SUMMARY OF THE INVENTION

Accordingly, at least one objective of the present invention is to provide a method for controlling outgoing electronic mails. By checking the mailing addresses of the electronic mails, those mailing addresses not included within a list of predetermined mailing addresses are specially highlighted so that the sending a document wrongfully to a mailing address outside the predetermined mailing addresses can be prevented.

At least another objective of the present invention is to provide a method for controlling outgoing electronic mails. The user is provided with an internal mailing field for sending internal documents. When the mailing address input by the user does not match with the predetermined addresses, the non-matching address is specially highlighted so that the user is reminded not to send the mail wrongfully to an external destination.

At least a third objective of the present invention is to provide a method for controlling outgoing electronic mails. By actuating a preset checking program, external mailing addresses in a mailing field are automatically deleted. Hence, there is no need to re-enter the mailing addresses and is prevented from having deletion mistakes and omissions.

To achieve these and other advantages and in accordance with the purpose of the invention, as embodied and broadly described herein, the invention provides a method for controlling outgoing electronic mail. The method includes setting up at least one predetermined mailing address and then checking the mailing address of an electronic mail. Thereafter, the mailing address is compared with the predetermined mailing address to check whether they are identical. If the mailing address and the predetermined mailing address are different, the mailing address is specially highlighted. On the other hand, if the mailing address and the predetermined mailing address are identical, the mailing address is preserved without any changes. Afterwards, electronic mails are sent to the mailing addresses that are not specially highlighted.

According to the aforementioned method for controlling electronic mails in the preferred embodiment of the present invention, before checking the mailing address of the electronic mail, further includes writing a mailing address to the internal mailing field of an electronic mail.

According to the aforementioned method for controlling electronic mails in the preferred embodiment of the present invention, before checking the mailing address of the electronic mail, further includes initiating a group of checking instructions.

According to the aforementioned method for controlling electronic mails in the preferred embodiment of the present invention, the method for initiating the checking instructions includes clicking a predetermined button.

According to the aforementioned method for controlling electronic mails in the preferred embodiment of the present invention, the step of specially highlighting the mailing address includes comprises at least one of the following: reversing a foreground color and a background color of the mailing address, changing the font size of the mailing address, and changing a color of the mailing address.

According to the aforementioned method for controlling electronic mails in the preferred embodiment of the present invention, the predetermined mailing addresses are set according to a domain name designated by the user, set by the input provided by a user or selected from a communication list.

According to the aforementioned method for controlling electronic mails in the preferred embodiment of the present invention, the mailing address can be written into a plurality of mailing fields of the electronic mails.

According to the aforementioned method for controlling electronic mails in the preferred embodiment of the present invention, the mailing fields include a receiver field, a copy field and a security field.

The invention provides an alternative method for controlling outgoing electronic mail. The method includes setting up at least one predetermined mailing address, writing a mailing address to an internal mailing field of an electronic mail and receiving a checking instruction to compare the mailing address with the predetermined mailing address to check whether they are identical. If the mailing address and the predetermined mailing address are identical, the mailing address is specially highlighted. On the other hand, if the mailing address and the predetermined mailing address are different, the mailing address is preserved without any changes. Afterwards, electronic mails are sent to the mailing addresses that are not specially highlighted.

According to the aforementioned method for controlling electronic mails in the preferred embodiment of the present invention, the method for initiating the checking instructions includes clinking a predetermined button.

The present invention performs an automatic mailing address check as a security procedure so that the input mailing address provided by the user is simultaneously compared to the predetermined mailing address to determine whether they match. With this setup, the need to re-enter input mailing addresses with the possibility of deletion mistakes and omission can be avoided. Moreover, special highlighting method is also used to remind and prevent a user from sending the wrong mail to an external destination.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow diagram showing the steps for controlling outgoing electronic mails according to one preferred embodiment of the present invention.

FIG. 2 is a flow diagram showing the steps for controlling outgoing electronic mails according to another preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

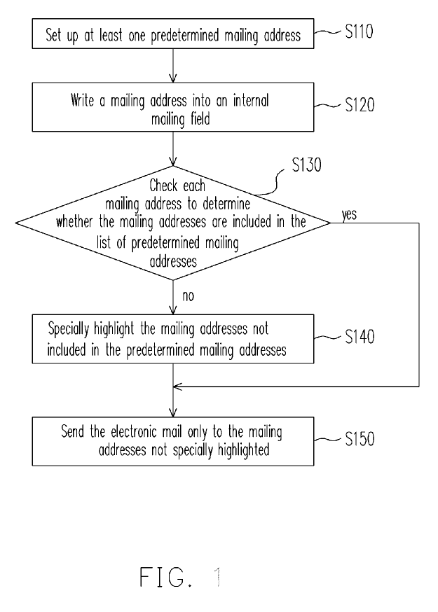

FIG. 1 is a flow diagram showing the steps for controlling outgoing electronic mails according to one preferred embodiment of the present invention. In the present embodiment, an additional internal mailing field is set up within a mail sending software. When a user inputs mailing address to this field, an automatic checking procedure is initiated so that the only the monitored electronic mails can be sent to the internal mailing addresses. When the automatic checking procedure is disabled, electronic mails can still be sent to internal and external mailing addresses. Thus, this setup not only provides user with greater flexibility, but also facilitates the sending of an electronic mail to the correct address quickly. Furthermore, the aforementioned mail sending software can be implemented by modifying existing software (for example, Microsoft Outlook) or designing anew.

In the present embodiment, the user sets up at least a predetermined mailing address in the mail sending software (in step S110). The method of setting the predetermined mailing address includes using a user-designated domain name (for example, Compal Electronics, Inc. may use compal.com as the designated domain name), or using an electronic mail address input by the user. Alternatively, an electronic mail address may be selected from a communication list. Thereafter, at least a batch of mailing addresses are written into the additional internal mailing field of the mail sending software so that the automatic checking procedure is initiated (in step S120).

After initiating the automatic checking procedure, the mail sending software will automatically check each mailing address within all mailing fields (for example, the receiver field, the copy field, the security field and the newly added internal mailing field) to determine whether it is included in the previously set predetermined mailing addresses (in step S130). If the mailing address is one among the predetermined mailing addresses, the mailing address is preserved without any changes. However, if the mailing address is not among the predetermined mailing addresses, this mailing address not included in the predetermined mailing address is specially highlighted to the user through the mail sending software (in step S140).

The method of specially highlighting the mailing addresses to the user includes reversing the foreground color and the background color of the batch of mailing addresses, or changing the font size and/or color of the mailing addresses, or issuing an alarm. In other words, when the user writes in a non-permitted mailing address, the system will sound an alarm to remind the user. However, this should by no means limit the scope of the present invention. In general, the user may choose some other special highlighting method and yet still be considered within the spirit of the present invention.

If the mailing address is one among the previously set predetermined mailing addresses or the mail sending software has already specially highlighted those mailing addresses not included within the predetermined mailing addresses, those electronic mails without a specially highlighted mailing address are sent (in step S150). Therefore, electronic mails can only be sent to the predetermined mailing addresses or the internal mailing addresses to achieve outgoing electronic mail control.

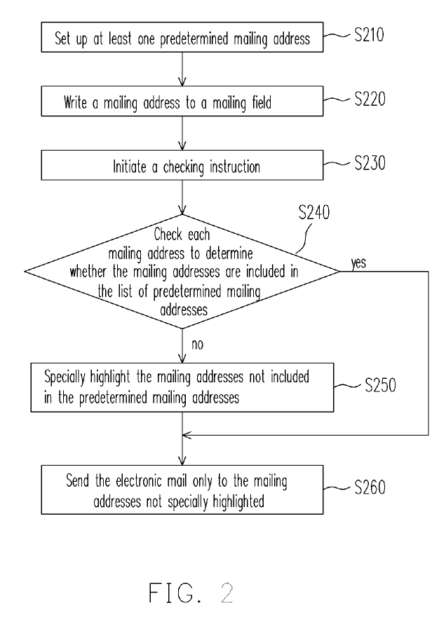

FIG. 2 is a flow diagram showing the steps for controlling outgoing electronic mails according to another preferred embodiment of the present invention. In the present embodiment, a user inputs mailing addresses to the mailing fields (for example, the receiver field, the copy field and the security field) originally belonging to the mail sending software and then initiates the automatic checking procedure of the mail sending software by point-clicking a predetermined button. Thereafter, the input mailing addresses are checked to determine whether they match any of the predetermined mailing addresses so that the user can send the mail to the correct address quickly.

In the present embodiment, the user sets up at least a predetermined mailing address through the mail sending software (in step S210). Then, a mailing address is written to the mailing field of the electronic mail (in step S220). Thereafter, the automatic checking procedure of the mail sending software is initiated by point-clicking a button in the mail sending software (in step S230). Hence, the mailing addresses in the mailing fields are automatically checked to determine whether they are among the previously set predetermined mailing addresses (in step S240). If the mailing address is included in the predetermined mailing addresses, the mailing address is preserved without any changes. On the other hand, if the mailing address is not included in the predetermined mailing addresses, the mailing address not included in the predetermined mailing addresses is specially highlighted through the mail sending software (in step S250).

The method of specially highlighting the mailing addresses to the user includes reversing the foreground color and the background color of the batch of mailing addresses or changing the font size and.or color of the mailing addresses. However, this should by no means limit the scope of the present invention. In general, the user may choose some other special highlighting method and yet still be considered within the spirit of the present invention.

If the mailing address is one among the previously set predetermined mailing addresses or the mail sending software has already specially highlighted those mailing addresses not included within the predetermined mailing addresses, only those electronic mails without a specially highlighted mailing address are sent (in step S260).

In summary, the present invention provides a means of controlling outgoing electronic mails. By inputting mailing addresses to a newly added field or point-clicking a button after inputting the mailing addresses, all input mailing addresses are automatically checked to determine whether they match the predetermined mailing addresses. Thus, aside from having no need to re-enter the mailing addresses as in the prior technique, the chance of having deletion mistakes or omission leading to an incomplete information security is significantly minimized.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for controlling outgoing electronic mails, comprising the steps of:
a. setting up a predetermined mailing address;
b. checking a mailing address of an electronic mail;
c. comparing the mailing address with the predetermined mailing address to determine whether they are identical;
c1. as the mailing address and the predetermined mailing address are different, specially highlighting the mailing address;
c2. as the mailing address and the predetermined mailing address are identical, preserving the mailing address without any changes; and
d. sending the electronic mail only to the mailing address and the predetermined mailing address being identical.

2. The method of claim 1, wherein before checking the mailing address of the electronic mail in the step b, further comprises:
b1. writing the mailing address into an internal mailing field of the electronic mail.

3. The method of claim 2, wherein before checking the mailing address of the electronic mail in the step b1, further comprises:
b2. initiating a checking instruction.

4. The method of claim 3, wherein the step of initiating the checking instruction comprises point-clicking a predetermined button.

5. The method of claim 1, wherein the step of specially highlighting the mailing address comprises at least one of the following: reversing a foreground color and a background color of the mailing address, changing the font size of the mailing address, and changing a color of the mailing address.

6. The method of claim 1, wherein the step of setting the predetermined mailing address comprises one of the following: setting the predetermined mailing address according to a user-designated domain name, setting the predetermined mailing address according to user input, and selecting the predetermined mailing address from a communication list.

7. The method of claim 1, wherein the mailing address can be written to a plurality of mailing fields of the electronic mails.

8. The method of claim 7, wherein the mailing fields include a receiver field, a copy field and a security field.

9. A method for controlling outgoing electronic mail, comprising the steps of:
a. setting a predetermined mailing address;
b. writing a mailing address into a mailing field of an electronic mail;
c. receiving a checking instruction for comparing whether the mailing address and the predetermined mailing address are identical;
c1. as the mailing address and the predetermined address are identical, specially highlighting the mailing address;
c2. as the mailing address and the predetermined address are different, preserving the mailing address without any changes; and
d. sending the electronic mail only to the mailing address and the predetermined mailing address being identical.

10. The method of claim 9, wherein the step of specially highlighting the mailing address comprises at least one of the following: reversing a foreground color and a background color of the mailing address, changing the font size of the mailing address, and changing a color of the mailing address.

11. The method of claim 9, wherein the step of setting the predetermined mailing address comprises one of the following: setting the predetermined mailing address according to a user-designated domain name, setting the predetermined mailing address according to user input, and selecting the predetermined mailing address from a communication list.

12. The method of claim 9, wherein the mailing fields includes a receiver field, a copy field and a security field.

13. The method of claim 9, wherein the checking instruction is initiated by point-clicking a predetermined button.
